(19) United States
(12) Patent Application Publication
(10) Pub. No.: US 2021/0310817 A1
(43) Pub. Date: Oct. 7, 2021

(54) ELECTRONIC DEVICE FOR VEHICLE, AND METHOD AND SYSTEM FOR OPERATING ELECTRONIC DEVICE FOR VEHICLE

(71) Applicant: LG Electronics Inc., Seoul (KR)

(72) Inventors: Jihyun KIM, Seoul (KR); Sungmin KIM, Seoul (KR)

(21) Appl. No.: 17/260,493

(22) PCT Filed: Nov. 12, 2018
(86) PCT No.: PCT/KR2018/013724

§ 371 Date: Jan. 14, 2021

(51) Int. Cl. G01C 21/34; G08G 1/0967; G08G 1/0968; G01C 21/00

(52) U.S. Cl. CPC G01C 21/3461; G08G 1/096775; G01C 21/3889; G08G 1/096827; G08G 1/096708

(57) ABSTRACT

An electronic device for a vehicle includes a power supply configured to supply power, an interface configured to receive high-definition (HD) map data of a specified region and event occurrence information from a server through a communication device, and a processor configured to continuously generate electronic horizon data of the specified region based on the HD map data in a state in which the power is received, and to change the electronic horizon data based on the event occurrence information.

### TECHNICAL FIELD

The present disclosure relates to an electronic device for a vehicle, and a method and system for operating an electronic device for a vehicle.

### BACKGROUND ART

A vehicle refers to a device that carries a passenger in a direction intended by a passenger. A car is a major example of such a vehicle. In the industrial field of vehicles, application of an advanced driver assistance system (ADAS) is under active study to increase the driving convenience of users. Furthermore, the application of autonomous driving of vehicles is also under active study.

The application of ADAS or the application of autonomous driving may be configured based on map data. Conventionally, low-scale standard definition (SD) map data is provided to users while being stored in a memory installed in a vehicle. However, recently, as the need for high-scale high-definition (HD) map data has increased, map data into which a cloud service is integrated has come to be provided to users.

When an unexpected event occurs while a vehicle travels, conventional ADAS application or autonomous driving application calculates a path using a deterministic method, and thus has a problem in that it is not possible to provide a path appropriate for a situation of an event.

### DISCLOSURE

### Technical Problem

To overcome the aforementioned problems, the present disclosure may provide an electronic device for a vehicle for changing electronic horizon data based on event occurrence information.

The present disclosure may provide a method of operating an electronic device for a vehicle for changing electronic horizon data based on event occurrence information.

The present disclosure may provide a system for changing electronic horizon data based on event occurrence information.

It will be appreciated by persons skilled in the art that that the effects that could be achieved with the present disclosure are not limited to what has been particularly described hereinabove and other advantages of the present disclosure will be more clearly understood from the detailed description.

### Technical Solution

In accordance with the present disclosure, the above and other objects can be accomplished by the provision of an electronic device for a vehicle, including a power supply configured to supply power, an interface configured to receive high-definition (HD) map data of a specified region and event occurrence information from a server through a communication device, and a processor configured to continuously generate electronic horizon data of the specified region based on the HD map data in a state in which the power is received, and to change the electronic horizon data based on the event occurrence information.

The electronic horizon data may include a main path defined as a trajectory formed by connecting a high probability of being selected and a sub path branching from at least one decision point on the main path.

When determining that the event occurs on the main path, the processor may change the main path to avoid a point at which the event occurs through a detour.

When determining that the event occurs on the sub path, the processor may enlarge the sub path.

The event may include a traffic accident event, and the processor changes the electronic horizon data in further consideration of path data of an emergency vehicle.

Details of other embodiments are included in detailed descriptions and drawings.

### Advantageous Effects

As is apparent from the foregoing description, the embodiments of the present disclosure have the following one or more effects.

It may be possible to normally drive advanced driver assistance system (ADAS) application or autonomous driving application even in situation in which a specific event occurs.

It will be appreciated by persons skilled in the art that that the effects that could be achieved with the present disclosure are not limited to what has been particularly described hereinabove and other advantages of the present disclosure will be more clearly understood from the following claims.

### DESCRIPTION OF DRAWINGS

FIG. 1 is a diagram showing a vehicle that travels on a road according to an embodiment of the present disclosure.

FIG. 2 is a diagram for explaining a system according to an embodiment of the present disclosure.

FIG. 3 is a diagram for explaining a vehicle including an electronic device according to an embodiment of the present disclosure.

FIG. 4 is diagram showing an example of the outer appearance of an electronic device according to an embodiment of the present disclosure.

FIGS. 5A to 5C are flowcharts of a signal inside a vehicle including an electronic device according to an embodiment of the present disclosure.

FIGS. 6A and 6B are diagrams for explaining an operation of receiving high-definition (HD) map data according to an embodiment of the present disclosure.

FIG. 6C is a diagram for explaining an operation of generating electronic horizon data according to an embodiment of the present disclosure.

FIG. 7 is a flowchart of an electronic device according to an embodiment of the present disclosure.

FIGS. 8 to 11 are diagrams for explaining an operation of an electronic device according to an embodiment of the present disclosure.

### BEST MODE

Reference will now be made in detail to exemplary embodiments of the present disclosure, examples of which are illustrated in the accompanying drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purposes of clarity and brevity. The features of the present disclosure will be more clearly understood from the accompanying drawings, and should not be understood to be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, “third” etc. may be used herein to describe various elements, these elements should not be limited by these terms. These terms are only used to distinguish one element from another element.

It will be understood that when an element is referred to as being “on”, “connected to” or “coupled to” another element, it may be directly on, connected to or coupled to the other element, or intervening elements may be present. In contrast, when an element is referred to as being “directly on,” “directly connected to” or “directly coupled to” another element or layer, there are no intervening elements present.

Singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof.

In the description below, the left side of the vehicle means the left side with respect to the travel direction of the vehicle and the right side of the vehicle means the right side with respect to the travel direction of the vehicle.

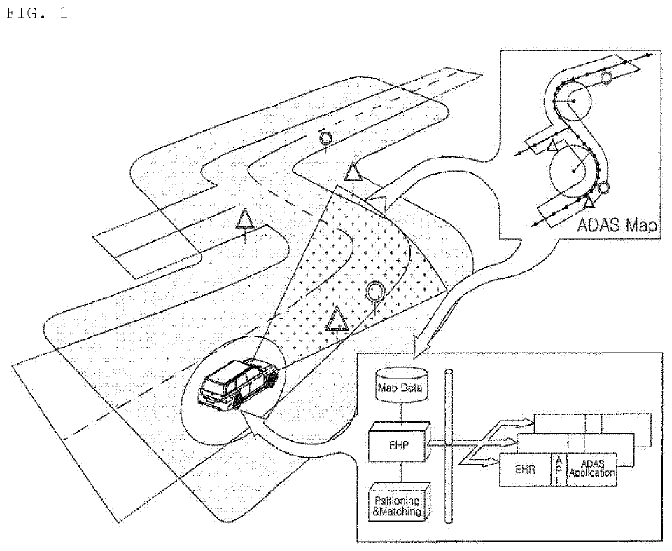

FIG. 1 is a diagram showing a vehicle that travels on a road according to an embodiment of the present disclosure.

Referring to FIG. 1, a vehicle 10 according to an embodiment may be defined as a form of a transport that travels on a road or rails. The vehicle 10 may be interpreted as including an automobile, a train, or a motorcycle. Hereinafter, an autonomous driving vehicle that travels without driver manipulation for driving or a vehicle including an advanced driver assistance system (ADAS) will exemplify the vehicle 10.

The vehicle described in this specification may include a vehicle equipped with an internal combustion engine as a power source, a hybrid vehicle equipped with both an engine and an electric motor as a power source, and an electric vehicle equipped with an electric motor as a power source.

The vehicle 10 may include an electronic device 100. The electronic device 100 may be referred to as an electronic horizon provider (EHP). The electronic device 100 may be conductively connected to another electronic device inside the vehicle 10 in the state of being installed in the vehicle 10.

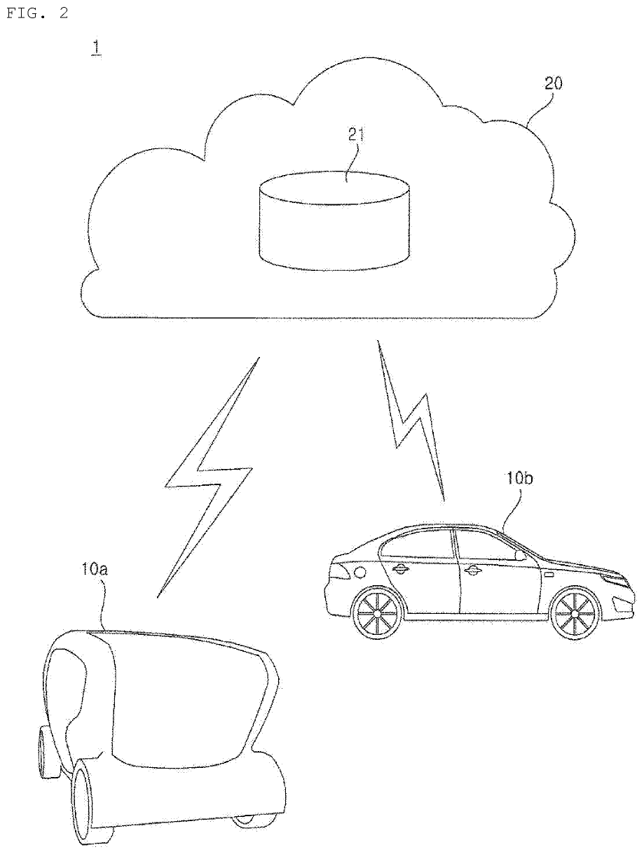

FIG. 2 is a diagram for explaining a system according to an embodiment of the present disclosure.

Referring to FIG. 2, a system 1 may include an infrastructure 20 and at least one vehicle 10a and 10b.

The infrastructure 20 may include at least one server 21. The server 21 may receive data generated by the vehicles l0a and 10b. The server 21 may process the received data. The server 21 may manipulate the received data.

The server 21 may receive data generated by at least one electronic device installed in the vehicles l0a and 10b. For example, the server 21 may receive data generated by at least one of an EHP, a user interface device, an object detection device, a communication device, a driving manipulation device, a main ECU, a vehicle-driving device, a travel system, a sensor, and a position-data-generating-device. The server 21 may generate big data based on the data received from a plurality of vehicles. For example, the server 21 may receive dynamic data from the vehicles 10a and 10b and may generate big data based on the received dynamic data. The server 21 may update HD map data based on the data received from a plurality of vehicles. For example, the server 21 may receive data generated by an object detection device from the EHP included in the vehicles l0a and 10b and may update HD map data.

The server 21 may provide pre-stored data to the vehicles l0a and 10b. For example, the server 21 may provide at least one of high-definition (HD) map data or standard definition (SD) map data to the vehicles l0a and 10b. The server 21 may classify the map data into map data for respective sections, and may provide only the map data corresponding to a section requested by the vehicles l0a and 10b. The HD map data may be referred to as high-precision map data.

The server 21 may provide data that is processed or manipulated by the server 21 to the vehicles 10a and 10b. The vehicles 10a and 10b may generate a travel control signal based on data received from the server 21. For example, the server 21 may provide the HD map data to the vehicles 10a and 10b. For example, the server 21 may provide dynamic data to the vehicles 10a and 10b.

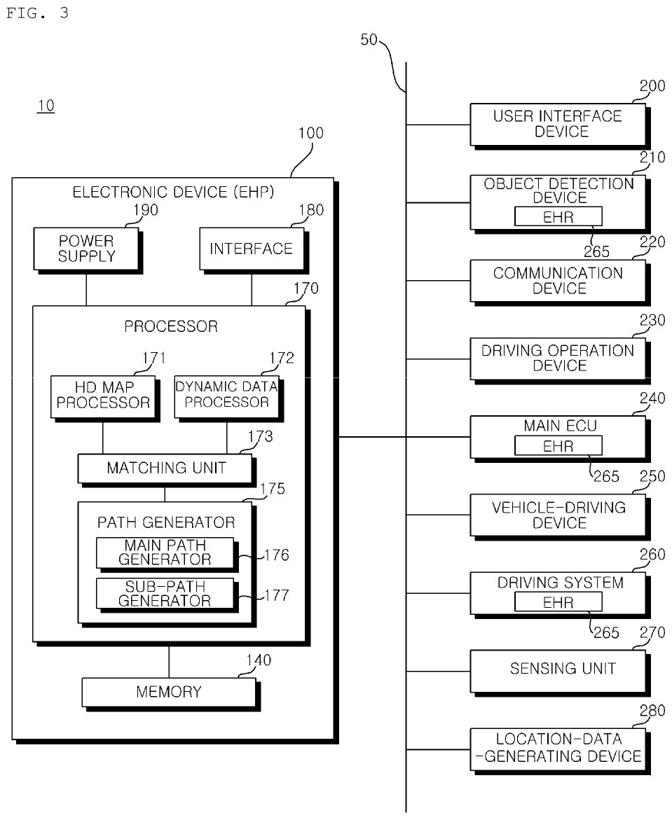

FIG. 3 is a diagram for explaining a vehicle including an electronic device according to an embodiment of the present disclosure.

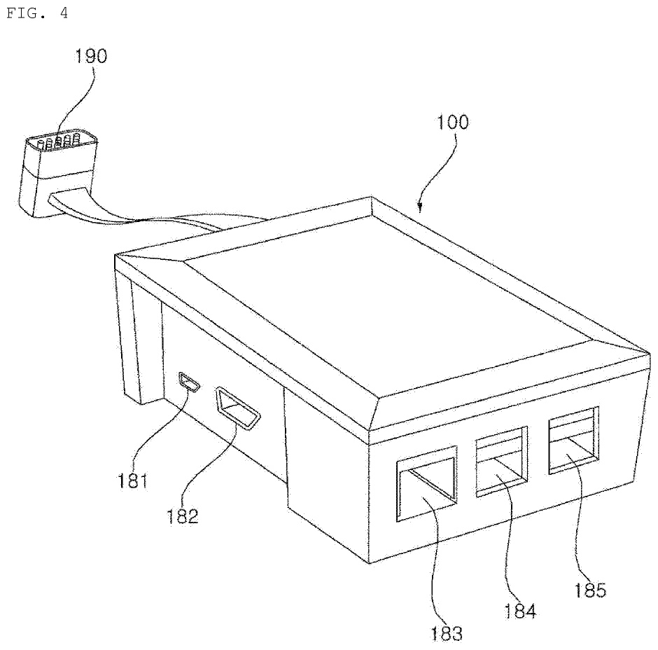

FIG. 4 is diagram showing an example of the outer appearance of an electronic device according to an embodiment of the present disclosure.

Referring to FIGS. 3 and 4, the vehicle 10 may include the electronic device 100, a user interface device 200, an object detection device 210, a communication device 220, a driving manipulation device 230, a main electronic control unit (ECU) 240, a vehicle-driving device 250, a travel system 260, a sensor 270, and a position-data-generating-device 280.

The electronic device 100 may be referred to as an electronic horizon provider (EHP). The electronic device 100 may generate electronic horizon data and may provide the same to at least one electronic device included in the vehicle 10.

The electronic horizon data may be described as driving plan data used to generate a travel control signal of the vehicle 10 in the travel system 260. For example, the electronic horizon data may be understood as driving plan data within a range to a horizon from the point where the vehicle 10 is positioned. Here, the horizon may be understood as a point a preset distance ahead of the point at which the vehicle 10 is positioned based on a preset travel path. The horizon may refer to a point that the vehicle 10 is capable of reaching after a predetermined time from the point at which the vehicle 10 is positioned along the preset traveling path. Here, the travel path may refer to a travel path to a final destination, and may be set by user input.

The electronic horizon data may include horizon map data and horizon path data.

The horizon map data may include at least one of topology data, ADAS data, HD map data, or dynamic data. In some embodiments, the horizon map data may include a plurality of layers. For example, the horizon map data may include a first layer matching the topology data, a second layer matching the ADAS data, a third layer matching the HD map data, and a fourth layer matching the dynamic data. The horizon map data may further include static object data.

The topology data may be described as a map made by connecting middle parts of roads. The topology data may be appropriate to broadly indicate the position of a vehicle and may be configured in the form of data that is mainly used in a navigation device for a driver. The topology data may be understood as data about road information other than information on lanes. The topology data may be generated based on data received from the infrastructure 20. The topology data may be based on data generated by the infrastructure 20. The topology data may be based on data stored in at least one memory included in the vehicle 10.

The ADAS data may refer to data related to information on a road. The ADAS data may include at least one of data on a slope of a road, data on a curvature of a road, or data on a speed limit of a road. The ADAS data may further include data on a no-passing zone. The ADAS data may be based on data generated by the infrastructure 20. The ADAS data may be based on data generated by the object detection device 210. The ADAS data may be referred to as road information data.

The HD map data may include topology information in units of detailed lanes of a road, information on connection between lanes, and information on characteristics for localization of a vehicle (e.g., a traffic sign, lane marking/attributes, or road furniture). The HD map data may be based on data generated by the infrastructure 20.

The dynamic data may include various pieces of dynamic information to be generated on a road. For example, the dynamic data may include information on construction, information on variable-speed lanes, information on the state of a road surface, information on traffic, and information on moving objects. The dynamic data may be based on data received from the infrastructure 20. The dynamic data may be based on data generated by the object detection device 210.

The electronic device 100 may provide map data within a range to a horizon from the point where the vehicle 10 is positioned.

The horizon path data may be described as the trajectory of the vehicle 10 within a range to a horizon from the point where the vehicle 10 is positioned. The horizon path data may include data indicating the relative probability of selection of any one among roads at a decision point (e.g., a forked road, a junction, or an intersection). The relative probability may be calculated based on the time taken to reach a final destination. For example, when a first road is selected at the decision point, if the time taken to reach a final destination is shorter than in the case in which a second road is selected, the probability of selecting the first road may be calculated to be higher than the probability of selecting the second road.

The horizon path data may include a main path and a sub path. The main path may be understood as a trajectory formed by connecting roads having a high probability of being selected. The sub path may branch from at least one decision point on the main path. The sub path may be understood as a trajectory formed by connecting roads having a low probability of being selected from at least one decision point on the main path.

The electronic device 100 may include an interface 180, a power supply 190, a memory 140, and a processor 170.

The interface 180 may exchange a signal with at least one electronic device included in the vehicle 10 in a wired or wireless manner. The interface 180 may exchange a signal with at least one of the user interface device 200, the object detection device 210, the communication device 220, the driving manipulation device 230, the main ECU 240, the vehicle-driving device 250, the travel system 260, the sensor 270, or the position-data-generating-device 280 in a wired or wireless manner. The interface 180 may include at least one of a communication module, a terminal, a pin, a cable, a port, a circuit, an element, or a device.

The power supply 190 may supply power to the electronic device 100. The power supply 190 may receive power from a power source (e.g., a battery) included in the vehicle 10 and may provide power to each unit of the electronic device 100. The power supply 190 may operate according to a control signal provided from the main ECU 240. The power supply 190 may be embodied as a switched-mode power supply (SMPS).

The memory 140 is conductively connected to the controller 170. The memory 140 may store default data for a unit, control data for controlling the operation of the unit, and input and output data. The memory 140 may be any of various storage devices in hardware, such as read only memory (ROM), random access memory (RAM), erasable and programmable ROM (EPROM), flash drive, and hard drive. The memory 140 may store various data for the overall operation of the vehicle 100, such as programs for processing or controlling in the controller 170.

The processor 170 may be conductively connected to the interface 180 and the power supply 190 and may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions.

The processor 170 may be driven by power provided from the power supply 190. The processor 170 may continuously generate electronic horizon data in the state in which the power supply 190 supplies power.

The processor 170 may generate electronic horizon data. The processor 170 may generate electronic horizon data. The processor 170 may generate horizon path data.

The processor 170 may generate electronic horizon data by applying a traveling situation of the vehicle 10. For example, the processor 170 may generate the electronic horizon data based on traveling direction data and traveling speed data of the vehicle 10.

The processor 170 may combine the generated electronic horizon data with the pre-generated electronic horizon data. For example, the processor 170 may connect horizon map data generated at a first time with horizon map data generated at a second time in terms of position. For example, the processor 170 may connect horizon path data generated at a first time with horizon path data generated at a second time in terms of position.

The processor 170 may provide electronic horizon data. The processor 170 may provide the electronic horizon data to at least one of the travel system 260 or the main ECU 240 through the interface 180.

The processor 170 may include the memory 140, an HD map processor 171, a dynamic data processor 172, a matcher 173, and a path generator 175.

The HD map processor 171 may receive HD map data from the server 21 through the communication device 220. The HD map processor 171 may store the HD map data. In some embodiments, the HD map processor 171 may process and manipulate the HD map data.

The dynamic data processor 172 may receive dynamic data from the object detection device 210. The dynamic data processor 172 may receive the dynamic data from the server 21. The dynamic data processor 172 may store the dynamic data. In some embodiments, the dynamic data processor 172 may process and manipulate the dynamic data.

The matcher 173 may receive an HD map from the HD map processor 171. The matcher 173 may receive the dynamic data from the dynamic data processor 172. The matcher 173 may generate horizon map data by matching the HD map data and the dynamic data.

In some embodiments, the matcher 173 may receive topology data. The matcher 173 may receive ADAS data. The matcher 173 may generate horizon map data by matching topology data, ADAS data, HD map data, and dynamic data.

The path generator 175 may generate horizon path data. The path generator 175 may include a main path generator 176 and a sub path generator 177. The main path generator 176 may generate main path data. The sub path generator 177 may generate sub path data.

The electronic device 100 may include at least one printed circuit board (PCB). The interface 180, the power supply 190, and the processor 170 may be conductively connected to the PCB.

In some embodiments, the electronic device 100 may be integrated into the communication device 220. In this case, the vehicle 10 may include the communication device 220 as a lower-ranking component of the electronic device 100.

The user interface device 200 may be a device for communication between the vehicle 10 and a user. The user interface device 200 may receive user input and may provide information generated by the vehicle 10 to a user. The vehicle 10 may embody a user interface (UI) or user experience (UX) through the user interface device 200.

The object detection device 210 may detect an object outside the vehicle 10. The object detection device 210 may include at least one of a camera, a RADAR, a LiDAR, an ultrasonic sensor, or an infrared sensor. The object detection device 210 may provide data on an object, generated based on a sensing signal generated by a sensor, to at least one electronic device included in a vehicle.

The object detection device 210 may generate dynamic data based on a sensing signal for sensing an object. The object detection device 210 may provide the dynamic data to the electronic device 100.

The object detection device 210 may receive electronic horizon data. The object detection device 210 may include an electronic horizon re-constructor (EHR) 265. The EHR 265 may convert the electronic horizon data into the data format to be used in the object detection device 210.

The communication device 220 may exchange a signal with a device positioned outside the vehicle 10. The communication device 220 may exchange a signal with at least one of an infrastructure (e.g., a server) or other vehicles. The communication device 220 may include at least one of a transmission antenna and a reception antenna for communication, and a radio frequency (RF) circuit or an RF device for embodying various communication protocols.

The driving manipulation device 230 may be a device for receiving user input for driving. In the case of a manual mode, the vehicle 10 may be driven based on a signal provided by the driving manipulation device 230. The driving manipulation device 230 may include a steering input device (e.g., a steering wheel), an acceleration input device (e.g., an accelerator pedal), and a brake input device (e.g., a brake pedal).

The main ECU 240 may control the overall operation of at least one electronic device included in the vehicle 10.

The main ECU 240 may receive electronic horizon data. The main ECU 240 may include an electronic horizon re-constructor (EHR) 265. The EHR 265 may convert the electronic horizon data into a data format to be used in the main ECU 240.

The vehicle-driving device 250 may be a device for electrical control of various devices in the vehicle 10. The vehicle-driving device 250 may include a powertrain driver, a chassis driver, a door/window driver, a safety device driver, a lamp driver, and a conditioning driver. The powertrain driver may include a power source driver and a transmission driver. The chassis driver may include a steering driver, a brake driver, and a suspension driver.

The travel system 260 may perform a traveling operation of the vehicle 10. The travel system 260 may provide a control signal to at least one of a powertrain driver or a chassis driver of the vehicle-driving device 250, and may move the vehicle 10.

The travel system 260 may receive electronic horizon data. The travel system 260 may include an electronic horizon re-constructor (EHR) 265. The EHR 265 may convert the electronic horizon data into a data format to be used in an ADAS application and an autonomous driving application.

The travel system 260 may include at least one of an ADAS application or an autonomous driving application. The travel system 260 may generate a travel control signal using at least one of the ADAS application and the autonomous driving application.

The sensor 270 may sense the state of a vehicle. The sensor 270 may include at least one of an inertial navigation unit (IMU) sensor, a collision sensor, a wheel sensor, a speed sensor, an inclination sensor, a weight detection sensor, a heading sensor, a position module, a vehicle forward/backward sensor, a battery sensor, a fuel sensor, a tire sensor, a steering sensor using rotation of a steering wheel, a vehicle interior temperature sensor, a vehicle interior humidity sensor, an ultrasonic sensor, an illumination sensor, an accelerator pedal position sensor, or a brake pedal position sensor. The inertial navigation unit (IMU) sensor may include one or more of an acceleration sensor, a gyro sensor, and a magnetic sensor.

The sensor 270 may generate data on the state of the vehicle based on a signal generated by at least one sensor. The sensor 270 may acquire a sensing signal for sensing vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward information, battery information, fuel information, tire information, vehicle lamp information, vehicle interior temperature information, vehicle interior humidity information, steering wheel rotation angle, vehicle external illumination, the pressure applied to an accelerator pedal, the pressure applied to a brake pedal, and the like.

In addition, the sensor 270 may further include an accelerator pedal sensor, a pressure sensor, an engine rotation speed sensor, an air flow sensor (AFS), an air temperature sensor (ATS), a water temperature sensor (WTS), a throttle position sensor (TPS), a TDC sensor, and a crank angle sensor (CAS).

The sensor 270 may generate vehicle state information based on sensing data. The vehicle state information may be information generated based on data detected by various sensors included in a vehicle.

For example, the vehicle state information may include vehicle posture information, vehicle speed information, vehicle inclination information, vehicle weight information, vehicle direction information, vehicle battery information, vehicle fuel information, vehicle tire air-pressure information, vehicle steering information, vehicle interior temperature information, vehicle interior humidity information, pedal position information, and vehicle engine temperature information.

The position-data-generating-device 280 may generate position data of the vehicle 10. The position-data-generating-device 280 may include at least one of a global positioning system (GPS) or a differential global positioning system (DGPS). The position-data-generating-device 280 may generate position data of the vehicle 10 based on a signal generated by at least one of the GPS or the DGPS. In some embodiments, the position-data-generating-device 280 may correct the position data based on at least one of an inertial measurement unit (IMU) of the sensor 270 or a camera of the object detection device 210.

The vehicle 10 may include an internal communication system 50. A plurality of electronic devices included in the vehicle 10 may exchange a signal using the internal communication system 50 as a medium. The signal may include data. The internal communication system 50 may use at least one communication protocol (e.g., CAN, LIN, FlexRay, MOST, or Ethernet).

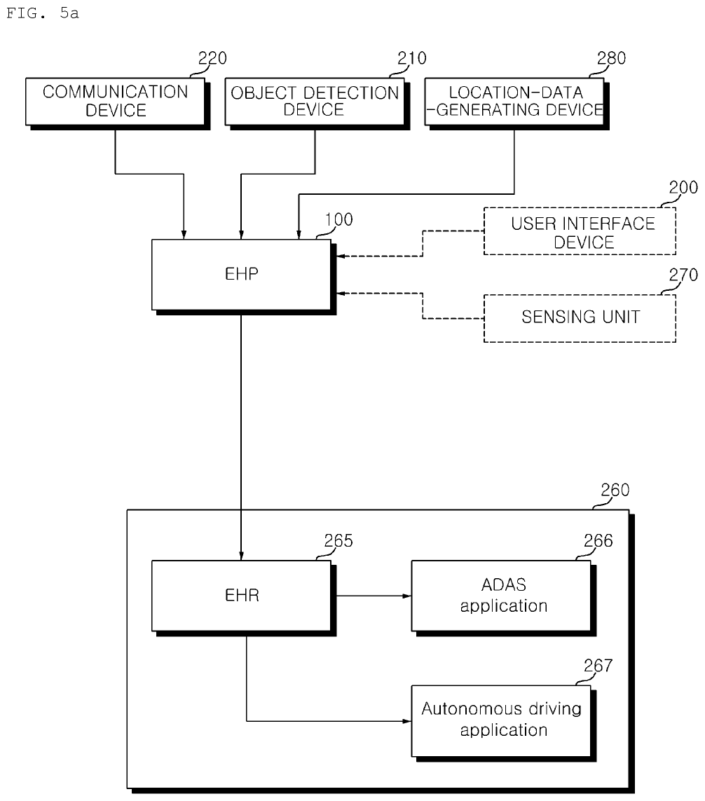

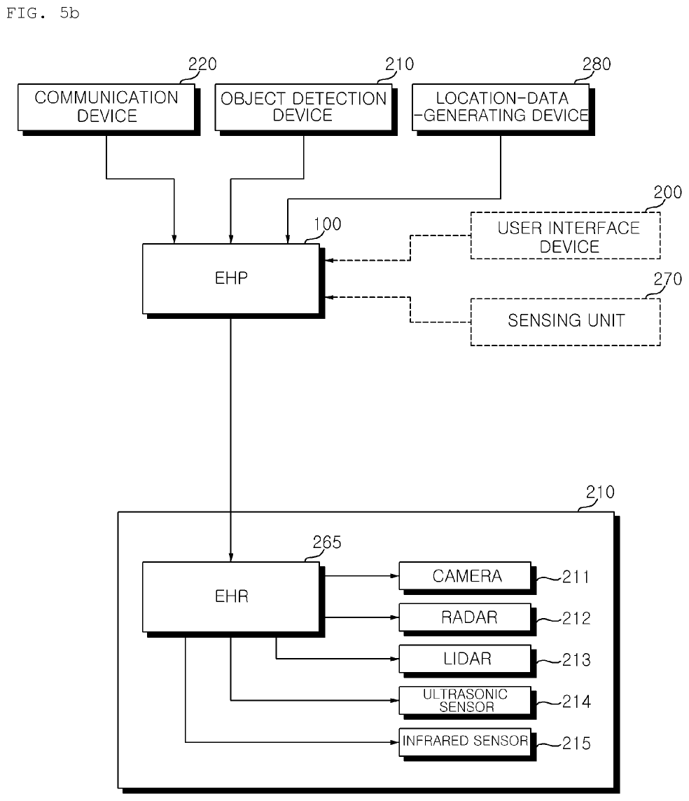

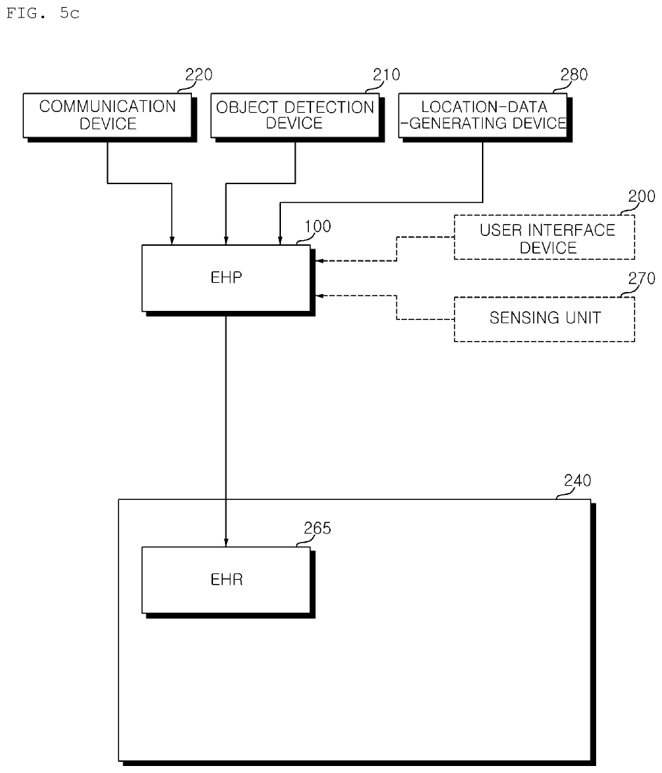

FIG. 5A is a flowchart of a signal inside a vehicle including an electronic device according to an embodiment of the present disclosure.

Referring to FIG. 5A, the electronic device 100 may receive HD map data from the server 21 through the communication device 220.

The electronic device 100 may receive dynamic data from the object detection device 210. In some embodiments, the electronic device 100 may also receive dynamic data from the server 21 through the communication device 220.

The electronic device 100 may receive position data of a vehicle from the position-data-generating-device 280.

In some embodiments, the electronic device 100 may receive a signal based on user input through the user interface device 200. In some embodiments, the electronic device 100 may receive vehicle state information from the sensor 270.

The electronic device 100 may generate electronic horizon data based on HD map data, dynamic data, and position data. The electronic device 100 may match the HD map data, the dynamic data, and the position data with each other to generate horizon map data. The electronic device 100 may generate horizon path data on a horizon map. The electronic device 100 may generate main path data and sub path data on the horizon map.

The electronic device 100 may provide electronic horizon data to the travel system 260. The EHR 265 of the travel system 260 may convert the electronic horizon data into a data format appropriate for applications 266 and 267. The applications 266 and 267 may generate a travel control signal based on the electronic horizon data. The travel system 260 may provide the travel control signal to the vehicle-driving device 250.

The travel system 260 may include at least one of an ADAS application 266 or an autonomous driving application 267. The ADAS application 266 may generate a control signal for assisting the driver in driving of the vehicle 10 through the driving manipulation device 230 based on the electronic horizon data. The autonomous driving application 267 may generate a control signal for moving the vehicle 10 based on the electronic horizon data.

FIG. 5B is a flowchart of a signal inside a vehicle including an electronic device according to an embodiment of the present disclosure.

With reference to FIG. 5B, the embodiment of the present disclosure will be described in terms of differences from FIG. 5A. The electronic device 100 may provide the electronic horizon data to the object detection device 210. The EHR 265 of the object detection device 210 may convert the electronic horizon data into a data format appropriate for the object detection device 210. The object detection device 210 may include at least one of a camera 211, a RADAR 212, a LiDAR 213, an ultrasonic sensor 214, or an infrared sensor 215. The electronic horizon data, the data format of which is converted by the EHR 265, may be provided to at least one of the camera 211, the RADAR 212, the LiDAR 213, the ultrasonic sensor 214, or the infrared sensor 215. At least one of the camera 211, the RADAR 212, the LiDAR 213, the ultrasonic sensor 214, or the infrared sensor 215 may generate data based on the electronic horizon data.

FIG. 5C is a flowchart of a signal inside a vehicle including an electronic device according to an embodiment of the present disclosure.

With reference to FIG. 5C, the embodiment of the present disclosure will be described in terms of differences from FIG. 5A. The electronic device 100 may provide electronic horizon data to the main ECU 240. The EHR 265 of the main ECU 240 may convert the electronic horizon data into a data format appropriate for the main ECU 240. The main ECU 240 may generate a control signal based on the electronic horizon data. For example, the main ECU 240 may generate a control signal for controlling at least one of the user interface device 180, the object detection device 210, the communication device 220, the driving manipulation device 230, the vehicle-driving device 250, the travel system 260, the sensor 270, or the position-data-generating-device 280 based on the electronic horizon data.

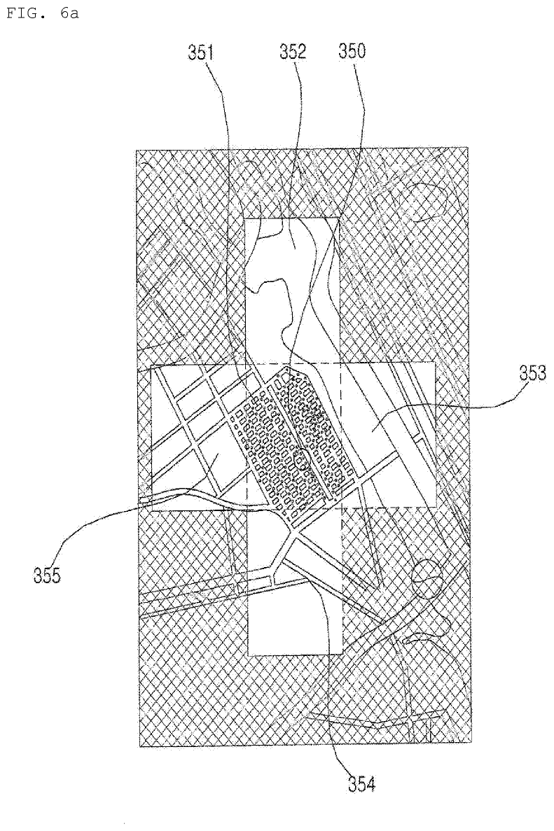

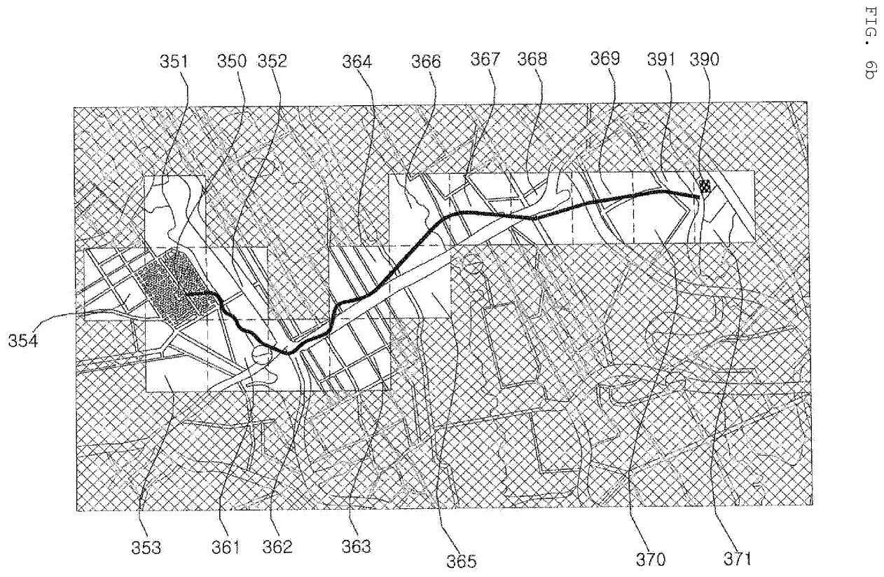

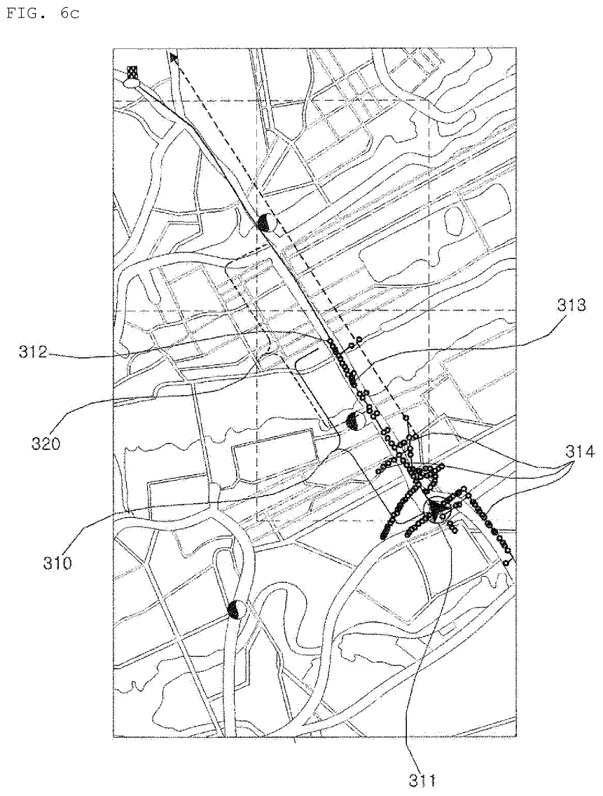

FIGS. 6A and 6B are diagrams for explaining an operation of receiving HD map data according to an embodiment of the present disclosure.

The server 21 may divide the HD map data in units of HD map tiles and may provide the divided HD map data to the electronic device 100. The processor 170 may download the HD map data in units of HD map tiles from the server 21 through the communication device 220.

An HD map tile may be defined as sub HD map data obtained by geographically dividing an entire HD map into rectangular shapes. All HD map data may be acquired by connecting all HD map tiles. The HD map data is high-scale data, and thus the vehicle 10 requires a high-performance controller to download all of the HD map data and to use the downloaded HD map data by the vehicle 10. As communication technologies have been developed, the vehicle 10 may download and use the HD map data in the form of HD map tiles and may thus obviate a high-performance controller rather than requiring inclusion of the high-performance controller, and thus may effectively process data.

The processor 170 may store the downloaded HD map tile in the memory 140. The processor 170 may delete the stored HD map tile. For example, the processor 170 may delete the HD map tile when the vehicle 10 moves out of a section corresponding to the HD map tile. For example, the processor 170 may delete the HD map tile when a preset time elapses since the HD map tile was stored.

FIG. 6A is a diagram for explaining an operation of receiving HD map data when there is no preset destination.

Referring to FIG. 6A, when there is no preset destination, the processor 170 may receive a first HD map tile 351 including a position 350 of the vehicle 10. The server 21 may receive data on the position 350 of the vehicle 10 from the vehicle 10 and may provide the first HD map tile 351 including a position 250 of the vehicle 10 to the vehicle 10. The processor 170 may receive HD map tiles 352, 353, 354, and 355 around the first HD map tile 351. For example, the processor 170 may receive the HD map tiles 352, 353, 354, and 355 that neighbor upper, lower, left, and right sides of the first HD map tile 351, respectively. In this case, the processor 170 may receive five HD map tiles in total. For example, the processor 170 may further receive an HD map tile positioned in a diagonal direction from the first HD map tile 351 along with the HD map tiles 352, 353, 354, and 355 that neighbor upper, lower, left, and right sides of the first HD map tile 351, respectively. In this case, the processor 170 may receive nine HD map tiles in total.

FIG. 6B is a diagram for explaining an operation of receiving HD map data when there is a preset destination.

Referring to FIG. 6B, when there is a preset destination, the processor 170 may receive tiles 350, 352, 361, 362, 363, 364, 365, 366, 367, 368, 369, 370, and 371 associated with a path 391 to the position 350 of the vehicle 10. The processor 170 may receive the plurality of tiles 350, 352, 361, 362, 363, 364, 365, 366, 367, 368, 369, 370, and 371 to cover the path 391.

The processor 170 may receive all of the tiles 350, 352, 361, 362, 363, 364, 365, 366, 367, 368, 369, 370, and 371, which cover the path 391, at one time.

While the vehicle 10 moves along the path 391, the processor 170 may separately receive all of the tiles 350, 352, 361, 362, 363, 364, 365, 366, 367, 368, 369, 370, and 371. While the vehicle 10 moves along the path 391, the processor 170 may receive only at least some of the tiles 350, 352, 361, 362, 363, 364, 365, 366, 367, 368, 369, 370, and 371 based on the position of the vehicle 10. Then, the processor 170 may continuously receive tiles and may delete the pre-received tiles while the vehicle 10 moves.

FIG. 6C is a diagram for explaining an operation of generating electronic horizon data according to an embodiment of the present disclosure.

Referring to FIG. 6C, the processor 170 may generate the electronic horizon data based on HD map data.

The vehicle 10 may travel in the state in which a final destination is set. The final destination may be set based on user input received through the user interface device 200 or the communication device 220. In some embodiments, the final destination may also be set by the travel system 260.

In the state in which the final destination is set, the vehicle 10 may be positioned within a preset distance from a first point while traveling. When the vehicle 10 is positioned within a preset distance from the first point, the processor 170 may generate electronic horizon data using a first point as a start point and a second point as an end point. Each of the first point and the second point may be one point on a path toward the final destination. The first point may be described as the point at which the vehicle 10 is currently positioned or is to be positioned in the near future. The second point may be described as the aforementioned horizon.

The processor 170 may receive an HD map of a region including a section to the second point from the first point. For example, the processor 170 may make a request for an HD map of a region within a predetermined radius from a section to the second point from the first point and may receive the HD map.

The processor 170 may generate electronic horizon data on a region including the section to the second point from the first point based on the HD map. The processor 170 may generate horizon map data of the region including the section to the second point from the first point. The processor 170 may generate horizon path data of the region including the section to the second point from the first point. The processor 170 may generate data on a main path 313 of the region including the section to the second point from the first point. The processor 170 may generate data on a sub path 314 of the region including the section to the second point from the first point.

When the vehicle 10 is positioned within a preset distance from the second point, the processor 170 may generate electronic horizon data using a second point as a start point and a third point as an end point. Each of the second point and the third point may be one point on a path toward a final destination. The second point may be described as a point at which the vehicle 10 is currently positioned or is to be positioned in the near future. The third point may be described as the aforementioned horizon. The electronic horizon data using the second point as a start point and the third point as an end point may be geographically connected to the aforementioned electronic horizon data using the first point as a start point and the second point as an end point.

The operation of generating the electronic horizon data using the first point as a start point and the second point as an end point may be applied in the same way to the operation of generating the electronic horizon data using the second point as a start point and the third point as an end point.

In some embodiments, the vehicle 10 may also travel in the state in which a final destination is not set.

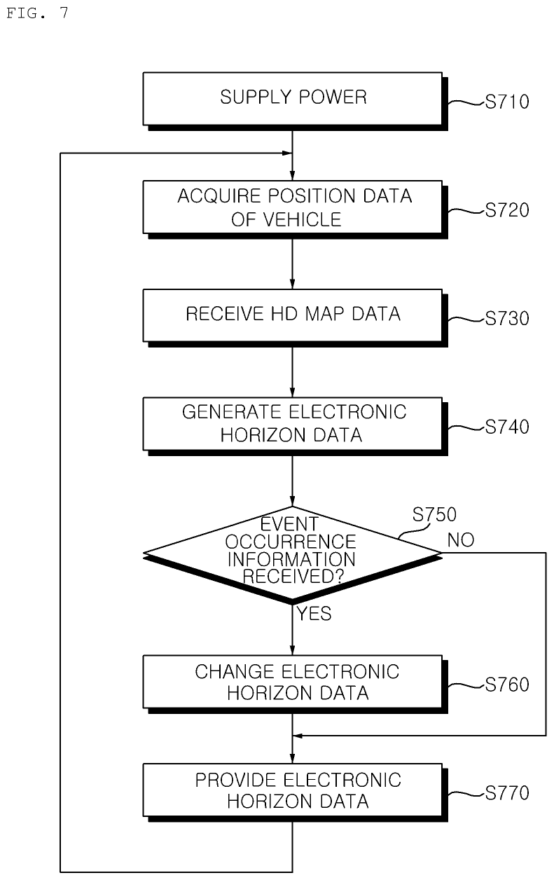

FIG. 7 is a flowchart of an electronic device according to an embodiment of the present disclosure.

Referring to FIG. 7, the processor 170 may receive power through the power supply 190 (S710). The power supply 190 may supply power to the processor 170. When the vehicle 10 is turned on, the processor 170 may receive power received from a battery included in the vehicle 10 through the power supply 190. When receiving power, the processor 170 may perform a processing operation.

The processor 170 may acquire position data of the vehicle 10 (S720). The processor 170 may receive the position data of the vehicle 10 from the position-data-generating-device 280 through the interface 180 by a predetermined interval. In the state in which the vehicle 10 travels, the interface 180 may receive the position data of the vehicle 10 from the position-data-generating-device 280. The interface 180 may transmit the received position data to the processor 170. The processor 170 may acquire the position data of the vehicle 10 in units of travel lanes.

The processor 170 may receive HD map data through the interface 180 (S730). In the state in which the vehicle 10 travels, the interface 180 may receive HD map data of a specified geographic region from the server 21 through the communication device 220. The interface 180 may receive the HD map data of the vicinity of the position of the vehicle 10. The interface 180 may transmit the received HD map data to the processor 170.

In the state in which power is received, the processor 170 may continuously generate electronic horizon data of a specified region based on the HD map data (S740). The processor 170 may generate electronic horizon data to a horizon from the position of the vehicle 10. The electronic horizon data may include horizon map data and horizon path data. The horizon path data may include a main path defined as a trajectory formed by connecting roads having a high probability of being selected and a sub path branching from at least one decision point on the main path.

When receiving the event occurrence information (S750), the processor 170 may change the electronic horizon data based on the event occurrence information (S760).

The processor 170 may receive the event occurrence information on a travel lane through the interface 180. In the state in which the vehicle 10 travels, the interface 180 may receive the event occurrence information on the travel path from the object detection device 210, from the server 21. The interface 180 may transmit the received event information to the processor 170. The event may include at least one of a traffic accident, road surface damage, road surface slip, or a disabled vehicle.

The changing operation S760 may include an operation of changing the main path to avoid the point at which an event occurs through a detour by at least one processor 170 when determining that the event occurs on the main path. When determining that the event occurs on the main path, the processor 170 may change the main path to avoid the point at which the event occurs through a detour.

The changing operation S760 may include an operation of enlarging the sub path by at least one processor 170 when determining that an event occurs on the sub path. When determining that the event occurs on the sub path, the processor 170 may enlarge the sub path.

The event may include a traffic accident event. The changing operation S760 may include an operation of changing electronic horizon data in further consideration of path data of an emergency vehicle by at least one processor 170. The processor 170 may change the electronic horizon data in further consideration of the path data of the emergency vehicle. The emergency vehicle may include at least one of an ambulance, a patrol car, or a fire engine.

The processor 170 may provide the electronic horizon data to the travel system 260 through the interface 180 (S770). The processor 170 may provide electronic horizon data corresponding to a set geographic range to the travel system 260 through the interface 180. The processor 170 may provide the changed electronic horizon data with a message corresponding to the event occurrence information. The processor 170 may provide the changed electronic horizon data to the travel system 260 and may provide the event occurrence information to the user interface device 200.

Then, the processor 170 may repeatedly perform operations subsequent to operation S720.

Operations S720 to S780 may be performed in the state in which power is received from the power supply 190.

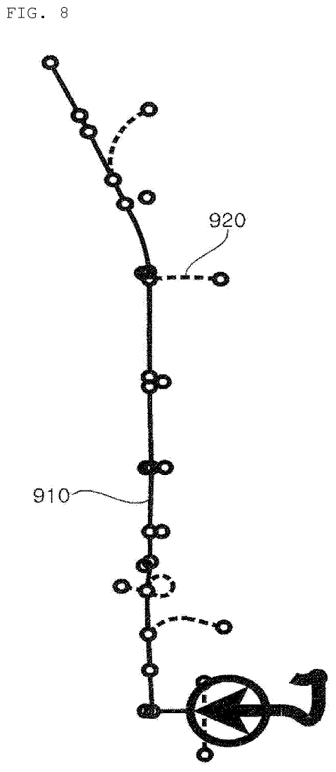

FIGS. 8 to 11 are diagrams for explaining an operation of an electronic device according to an embodiment of the present disclosure.

Referring to FIG. 8, the processor 170 may generate electronic horizon data. The electronic horizon data may include a main preferred path (MPP) 910 and a sub path 920. The processor 170 may generate the sub path 920 by a preset length.

The sub path 920 is commonly applied to all branch paths on the MPP 910, and thus when the sub path 920 is set a long way, sufficient data may be provided to the travel system 260. In contrast, when all paths of the sub path 920 are generated, high system costs of the electronic device 100 are required. When a vehicle deviates from the main path or deviates from a section having a main path generated in advance, the path may be updated, and thus it may not be possible to respond to a situation of an event that suddenly occurs.

The electronic device 100 according to an embodiment of the present disclosure may change electronic horizon data based on information on occurrence of an event 1010 even after a main path 1001 and a sub path are generated. The processor 170 may receive the information on occurrence of the event 1010 from the server 21. The processor 170 may receive the information on occurrence of the event 1010 from the communication device 220. The processor 170 may receive the information on occurrence of the event 1010 from the object detection device 210.

The processor 170 may determine whether an event occurs on the MPP 910. When determining that the event occurs on the MPP 910, the processor 170 may change the main path to avoid the point at which the event occurs through a detour.

The processor 170 may determine whether an event occurs on the sub path 920. When determining that the event occurs on the sub path 920, the processor 170 may enlarge or add the sub path including the point at which the event occurs.

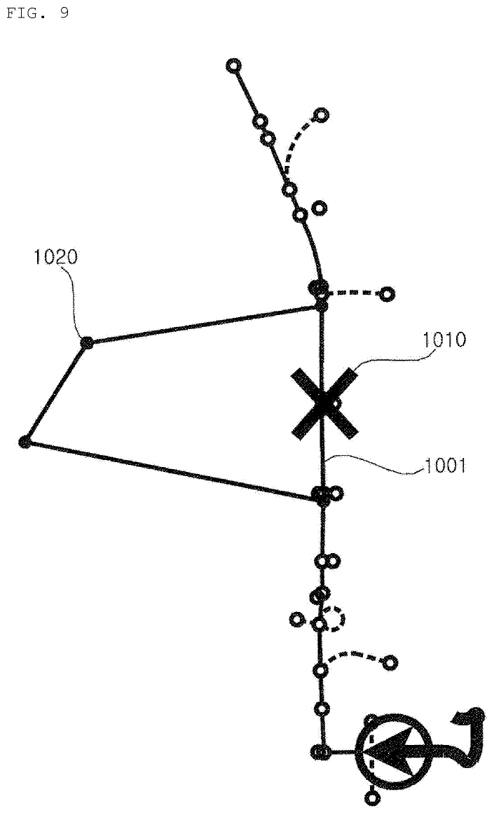

Referring to FIG. 9, when it is possible to ensure a path for avoiding only the point at which the event occurs through a short detour, the processor 170 may change the main path to avoid only the corresponding point through a detour. When the entire main path is changed, if a cost difference from the case in which the main path is changed to avoid only the corresponding point through a detour is not large, the processor 170 may change the entire main path. When receiving information on a traffic accident event, the processor 170 may change the entire main path in further consideration of information on whether a road is controlled and information on a path of an emergency vehicle.

As such, the electronic horizon data may be changed based on the event occurrence information, and thus it may be possible to respond to even an event that suddenly occurs.

A large amount of data of the sub path on a road in which an event does not occur may not be required. When event occurrence information is received while the length of the sub path is ordinarily maintained, the processor 170 may change the sub path.

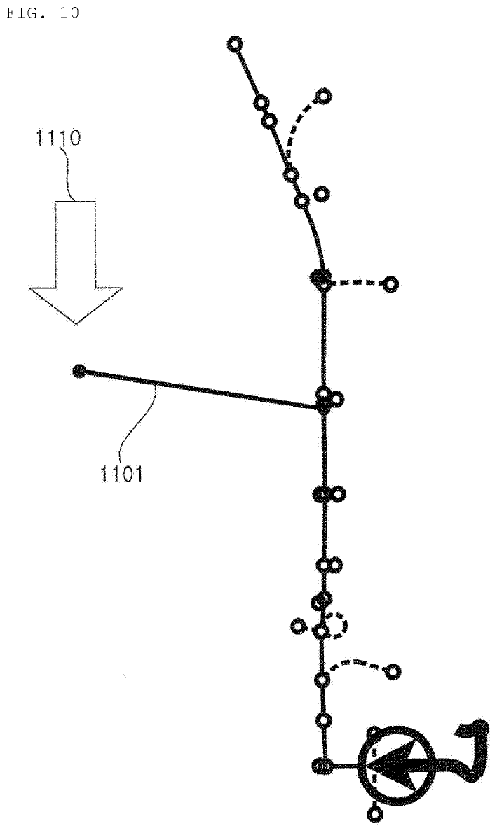

As shown in FIG. 10, the processor 170 may receive information on occurrence of an event 1110 on a first sub path 1101. When receiving information on occurrence of the event 1110 on the first sub path 1101, the processor 170 may enlarge the length of the first sub path 1101. The length of the first sub path 1101 may be enlarged, and thus more detailed information on the first sub path 1101 including information on occurrence of the event 1110 may be provided.

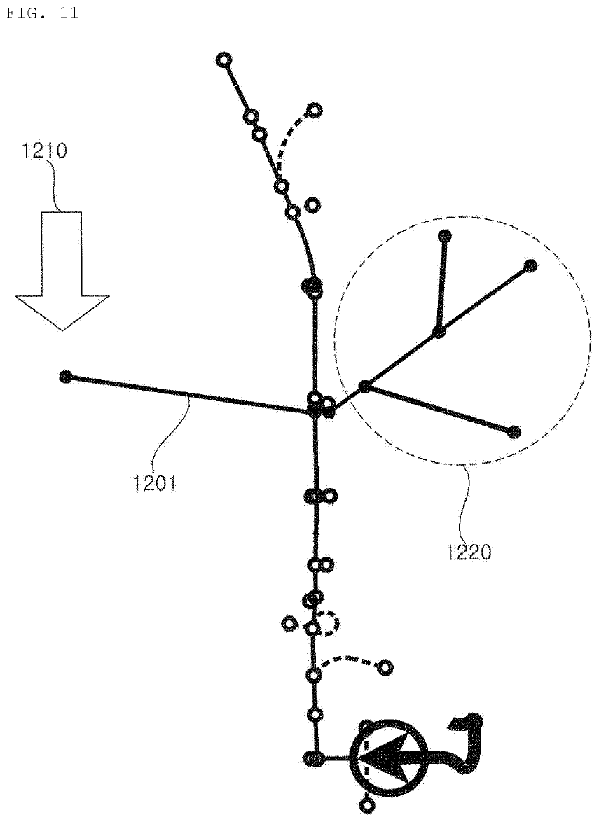

As shown in FIG. 11, the processor 170 may receive information on occurrence of an event 1210 on a first sub path 1201. When receiving information on occurrence of the event 1110 on the first sub path 1201, the processor 170 may increase the number of second sub paths 1220 that are different from the first sub path 1201. The number of the second sub paths 1220 may be increased, and thus a plurality of paths to be selected by the vehicle 10 may be ensured.

As such, a path may be dynamically changed depending on an event, and thus a sub path may be enlarged only when an event occurs while data of the sub path is simply generated at an ordinary time, and thus it may be possible to response to even an event while lowering system costs of the electronic device 100.

The aforementioned present disclosure can also be embodied as computer readable code stored on a computer readable recording medium. The computer readable recording medium is any data storage device that can store data which can thereafter be read by a computer. Examples of the computer readable recording medium include a hard disk drive (HDD), a solid state drive (SSD), a silicon disk drive (SDD), read-only memory (ROM), random-access memory (RAM), CD-ROM, magnetic tapes, floppy disks, optical data storage devices, carrier waves (e.g., transmission via the Internet), etc. The computer may include a processor or a controller. Accordingly, it is intended that the present disclosure cover the modifications and variations of this invention provided they come within the scope of the appended claims and their equivalents.

### DESCRIPTION OF REFERENCE NUMERAL

1: System

10: Vehicle

100: Electronic device

170: Processor

What is claimed:

1. An electronic device for a vehicle, comprising:
a power supply configured to supply power;
an interface configured to receive high-definition (HD) map data of a specified region and event occurrence information from a server through a communication device; and
a processor configured to continuously generate electronic horizon data of the specified region based on the HD map data in a state in which the power is received, and to change the electronic horizon data based on the event occurrence information.

2. The electronic device of claim 1, wherein the electronic horizon data comprises a main path defined as a trajectory formed by connecting a high probability of being selected and a sub path branching from at least one decision point on the main path.

3. The electronic device of claim 2, wherein, when determining that the event occurs on the main path, the processor changes the main path to avoid a point at which the event occurs through a detour.

4. The electronic device of claim 2, wherein, when determining that the event occurs on the sub path, the processor enlarges the sub path.

5. The electronic device of claim 1, wherein the event comprises a traffic accident event; and
wherein the processor changes the electronic horizon data in further consideration of path data of an emergency vehicle.

6. A method of operating an electronic device for a vehicle, the method comprising:
receiving power by at least one processor;
receiving high-definition (HD) map data of a specified region from a server through a communication device in a state in which the power is received, by the at least one processor;
generating electronic horizon data of the specified region based on the HD map data in the state in which the power is received, by the at least one processor; and
changing the electronic horizon data based on event occurrence information by the at least one processor.

7. The method of claim 6, wherein the electronic horizon data comprises a main path defined as a trajectory formed by connecting a high probability of being selected and a sub path branching from at least one decision point on the main path.

8. The method of claim 7, wherein the changing comprises, when determining that the event occurs on the main path, changing the main path to avoid a point at which the event occurs through a detour by the at least one processor.

9. The method of claim 7, wherein the changing comprises, when determining that the event occurs on the sub path, enlarging the sub path by the at least one processor.

10. The method of claim 6, wherein the event comprises a traffic accident event; and
wherein the changing comprises changing the electronic horizon data in further consideration of path data of an emergency vehicle by the at least one processor.

11. A system comprising:
a server configured to provide high-definition (HD) map data; and
at least one vehicle comprising an electronic device configured to receive the HD map data,
wherein the electronic device comprises:
a power supply configured to supply power;
an interface configured to receive HD map data of a specified region and event occurrence information from a server through a communication device; and
a processor configured to continuously generate electronic horizon data of the specified region based on the HD map data in a state in which the power is received, and to change the electronic horizon data based on the event occurrence information.

12. The system of claim 11, wherein the electronic horizon data comprises a main path defined as a trajectory formed by connecting a high probability of being selected and a sub path branching from at least one decision point on the main path.

13. The system of claim 12, when determining that the event occurs on the main path, the processor changes the main path to avoid a point at which the event occurs through a detour.

14. The system of claim 12, wherein, when determining that the event occurs on the sub path, the processor enlarges the sub path.

15. The system of claim 11, wherein the event comprises a traffic accident event; and
wherein the processor changes the electronic horizon data in further consideration of path data of an emergency vehicle.
